(19) United States
(12) Patent Application Publication
(10) Pub. No.: US 2025/0079904 A1
(43) Pub. Date: Mar. 6, 2025

(54) ENERGY SHARING SYSTEM THOUGH WIRELESS POWER TRANSFER

(71) Applicant: Soelect Inc., Greensboro, NC (US)

(72) Inventor: Sungjin Cho, Summerfield, NC (US)

(21) Appl. No.: 18/823,312

(22) Filed: Sep. 3, 2024

Related U.S. Application Data
(60) Provisional application No. 63/535,869, filed on Aug. 31, 2023.

(51) Int. Cl. H02J 50/20; B60L 53/12; B60L 53/53; H01M 10/42; H01M 10/46; H02J 50/40; H02J 50/80

(52) U.S. Cl. CPC H02J 50/20; B60L 53/12; B60L 53/53; H01M 10/425; H01M 10/46; H02J 50/40; H02J 50/80; H01M 2010/4271; H01M 2220/20

(57) ABSTRACT

A wireless energy sharing system includes a high energy and high power battery device configured to store energy and includes a lithium metal anode and an energy sharing transceiver device. The energy sharing transceiver is configured to: transmit, via radio frequency (RF) communications, energy stored in the battery device to one or more energy sharing additional transceiver devices while operating in an energy transmitting mode; receive energy from the one or more energy sharing additional transceiver devices and store the received energy in the battery device while operating in an energy receiving mode; and transmit and/or receive, via the RF communications, energy sharing data simultaneously with the respective transmission and/or reception of the energy.

### CROSS REFERENCE TO RELATED APPLICATIONS

This application is a continuation of U.S. Provisional Patent Application No. 63/535,869, filed on Aug. 31, 2023, the disclosure and content of which is incorporated by reference herein in its entirety.

### TECHNICAL FIELD

The present disclosure relates generally to bidirectional energy and power transfer conducted between rechargeable batteries, and more particularly to an energy sharing system that utilizes wireless power transfer.

### BACKGROUND

Wireless charging is presently utilized by consumer electronic gadgets and devices, but is not as common for other larger applications, such as in the electric vehicle (EV) or industrial field, for example. This is primarily due to the large amount of energy that an EV typically requires to operate as compared to the smaller energy demand of handheld electronic devices. Also, present day wireless charging is typically conducted in a single direction (i.e., unidirectional charging) from the power source (or a larger device) to a rechargeable device (or a smaller device).

Notably, the utilization of bi-directional energy transfer in the rechargeable battery market is largely non-existent. For smaller devices, it is convenient enough to plug in devices to a readily available battery charger thereby obviating the need to configure these handheld devices to transfer energy bi-directionally. In the context of larger EV batteries, currently deployed lithium ion battery packs do not have sufficient energy density to make bi-directional energy transfer feasible or practical (i.e., cost efficient). More specifically, currently used lithium ion batteries using graphite anodes have a relatively low power transfer efficiency in relation to its energy density. The use of currently available lithium ion batteries (LIBs) in particular decrease the efficiency of a high-efficiency power transfer system, which often requires high voltages and/or high currents to effectively perform the charging functionality due to structural combinations (e.g., series and/or parallel connection) of the battery cells contained within battery packs.

Despite the current limitations presented by present day battery charging technologies, improvements are needed especially when considering the high cost of constructing and maintaining the infrastructures, the charging stations, and the residential and/or industrial charging facilities necessary to resupply power to the number of EVs used today.

### SUMMARY

In one embodiment, the disclosed subject matter includes a wireless energy sharing system. The wireless energy sharing system includes a high energy and high power battery device configured to store energy and includes a lithium metal anode and an energy sharing transceiver device. The energy sharing transceiver is configured to: transmit, via radio frequency (RF) communications, energy stored in the battery device to one or more energy sharing additional transceiver devices while operating in an energy transmitting mode; receive energy from the one or more energy sharing additional transceiver devices and store the received energy in the battery device while operating in an energy receiving mode; and transmit and/or receive, via the RF communications, energy sharing data simultaneously with the respective transmission and/or reception of the energy.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of an energy sharing system in accordance with some embodiments;

FIG. 2 is a block diagram illustrating an example energy sharing network in accordance with some embodiments;

FIG. 3 is a schematic diagram illustrating an example of an energy sharing system utilizing a lithium metal battery in accordance with some embodiments;

FIG. 4 is a block diagram illustrating an exemplary energy sharing control manager device in accordance with some embodiments;

FIG. 5 is a table comparing various characteristics between a lithium ion battery and a lithium metal battery for electric vehicle (EV) applications;

FIG. 6 is a table comparing various wireless transmission and reception characteristics between a lithium ion battery and a lithium metal battery for EV applications;

FIG. 7 is a schematic diagram illustrating an example of an energy sharing system in accordance with some embodiments; and

FIG. 8 is a table comparing various wireless transmission and reception characteristics between a lithium ion battery and a lithium metal battery for EV applications.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The present disclosure relates generally to a novel method for sharing or transferring energy between two electronic devices equipped with lithium rechargeable batteries, such as electric vehicles (EVs), drones, or other like electronic devices. In some embodiment, this method employs a radio frequency (RF) wireless power transfer system that is utilized by two or more electronic devices, which enables them to receive and transmit energy to and/or from high-energy and high-power rechargeable batteries configured with lithium metal anodes. The energy storage system utilizing such batteries can conduct the RF wireless power transfer in various directions simultaneously. In some examples, this type of wireless energy transfer is referred to herein as “energy sharing” between two or more devices equipped with lithium metal batteries.

As used herein, a lithium metal battery (LMB) may refer to a rechargeable battery cell that includes Li metal in the anode electrode (e.g., instead of a graphite anode electrode). An LMB has a higher energy density and higher power than a lithium ion battery, and can be used by the disclosed energy sharing system to maximize its power transfer efficiency. Notably, the disclosed “energy sharing” system can mitigate many issues that arise in typical battery charging environments, such as space and/or area limitations associated with sizeable infrastructures by leveraging wireless charging technology more effectively together with high energy and high power LMBs. In particular, LMB batteries are ideally used due to their increased energy density, which is will be needed to sufficiently provide power to EVs and their advanced sensors and software systems, such as advanced driver-assistance systems (ADAS).

In some embodiments, the “energy sharing” functionality of the disclosed subject matter may be realized by adding an energy-sharing transceiver system and/or energy-sharing transceiver component to two or more devices (e.g., smart phones, EVs, or other host electronic devices) that are configured to utilize wireless energy transfer. As an example, such energy-sharing transceiver components may be installed in the bumpers (e.g., front and/or rear bumpers) of EVs, thereby allowing the transfer of energy as well as data via RF while the EVs are in motion. The subsequent disclosure and figures illustrate exemplary embodiments that depict utilizing of such transceiver components in one or more EVs.

Moreover, in some embodiments, the energy sharing system may include the addition and/or utilization of appropriate software (e.g., applications and/or an application operating on an EV computer and/or the user's mobile phone) that enables users to set and/or agree on the terms related to the subsequent transfer of energy to and/or from their EVs. In some embodiments, the EV computer may be embodied as a manager device described herein as an example. Further, the disclosed energy-sharing transceiver, which is communicatively connected to and/or integrated with the manager device, can be configured to transfer (i.e., transmit and receive) energy and data bi-directionally via a Multi-Input and Multi-Output (MIMO) manner.

In some embodiments, the disclosed energy-sharing system utilizes at least one transceiver component that is directly connected to the battery component (e.g., rechargeable battery unit(s)) of an EV. By collecting the energies from several other EVs (e.g., EVs that are operating proximate to the user's power receiving EV and are similarly configured with an energy-sharing transceiver to perform wireless energy-sharing), the power-receiving EV can compensate for the low efficiency issue in the energy transfer. For example, the power-receiving EV can be configured to receive a small percentage (e.g., 1%) of power from each of the energy-sharing transceivers of the many designated energy-sharing EVs encountered on the highway during a particular duration (e.g., during a portion of a road trip).

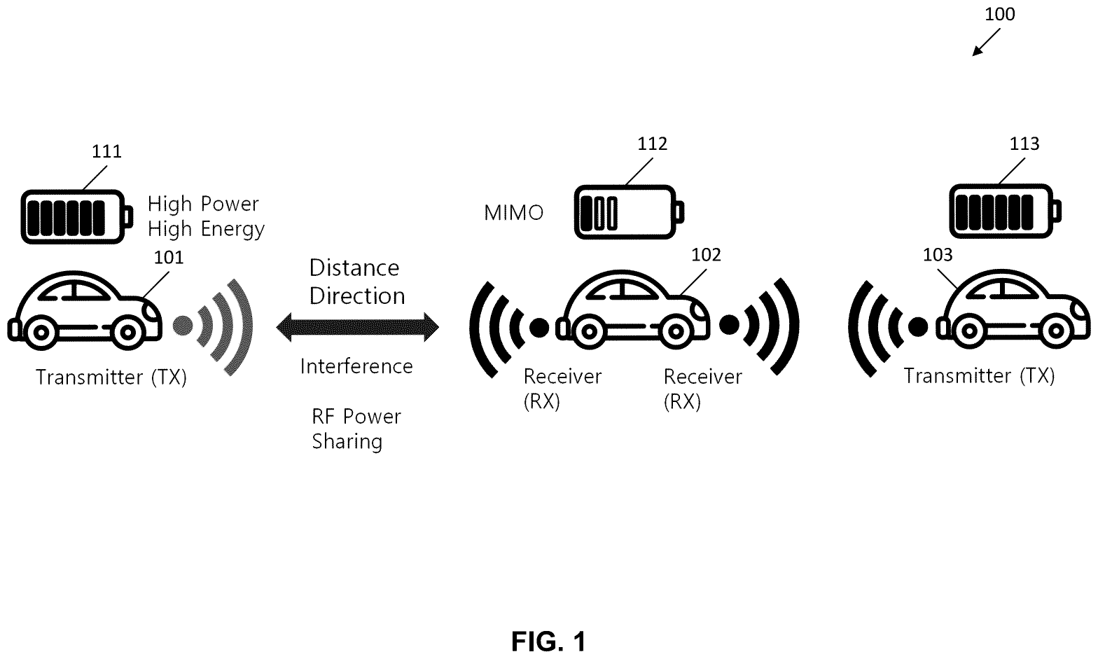

One example embodiment of the disclosed energy sharing system is illustrated in FIG. 1, which depicts a schematic of a plurality of EVs 101-103 transferring energy via wireless Radio-Frequency (RF) power transfer during vehicle operation at a distance. For example, a power-receiving EV 102 can receive power from many other EVs through two transceiver components that are operating in a receiver (Rx) mode, while the power-transferring EVs (e.g., EVs 101 and 103) can provide energy via transceiver components operating in a transmitter (Tx) mode. In some embodiments, the transceiver components (not shown in detail in FIG. 1) can be positioned in the front and/or rear bumper of each of EVs 101-103. Notably, the transceiver components described herein can be configured by the user and/or system to operate in an energy receiving mode or an energy transmitting mode. As shown in FIG. 1, power-transferring EVs 101-103 is each equipped with a high power and high energy rechargeable battery 111-113 (e.g., a LMB). Using multiple input and multiple output (MIMO) antennas equipped on their respective transceiver components, EVs 101 and 103 can wirelessly transmit energy from their relatively full LMBs 111 and 113 to the lightly charged LMB 112 while the EVs are in motion (e.g., driving on the road or highway).

The total energy transfer efficiency of the disclosed transceiver components is impacted by basic Tx-Rx efficiency and additional interferences, such as the moving distance, direction, weather, other electro-magnetic (EM) waves, and physical obstacles. In some embodiments, the disclosed wireless power transfer system enables energy sharing despite such interferences and obstacles. The relatively low power transfer efficiency exhibited by the system can be mitigated by the use of a high energy and high power battery system combined with MIMO RF antennas. Notably, the wireless RF power transfer technology is ideal for EV applications due to its ability to handle longer distances of power delivery as compared to inductive or magnetic resonance power transfer methods. More specifically, while RF power transfer technology may exhibit a lower power transfer efficiency compared to other transfer technologies, it is completely free from the alignment issue(s) that limit those non-RF power transfer technologies.

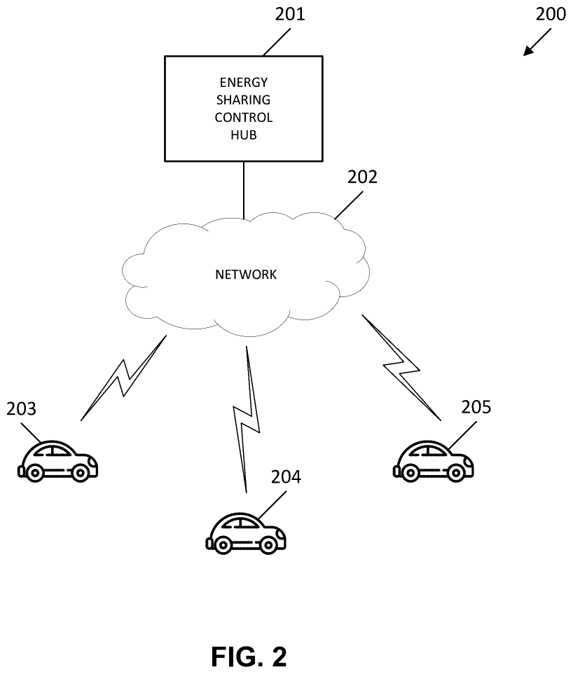

FIG. 2 illustrates an exemplary energy sharing network 200 that includes an energy sharing control hub 201 that is communicatively connected to a plurality of EVs 203-205 via a network 202 (e.g., the Internet). Although only three EVs 203-205 are depicted in FIG. 2, additional EVs can be supported by control hub 201 without deviating from the scope of the disclosed subject matter. In some embodiments, energy sharing control hub 201 may include one or more central computer devices (e.g., one or more computer servers) that collects and communicates data to and from EVs 203-205. For example, energy sharing control hub 201 may be configured to wireless communicate with each of the management devices and/or energy sharing transceiver components (described below and illustrated in subsequent figures) located on each of the EVs 203-205. Through a wireless transfer of information, an EV may provide energy sharing registration data, energy sharing use data (i.e., amount of energy transferred and/or received), energy sharing configuration data, EV location data, and any other like data. Such information and data may be transferred among the EVs simultaneously with the wireless transfer of energy and while the EVs are in motion (e.g., driving on the road). Likewise, control hub 201 may provide energy sharing authorization and/or permission data, transceiver configuration data, location data of participating/registered EVs, and the like. In some embodiments, the control hub and/or management devices in EVs 203-205 includes an energy sharing system software application that is configured to facilitate the communications between users and/or host devices registered in the wireless energy sharing system.

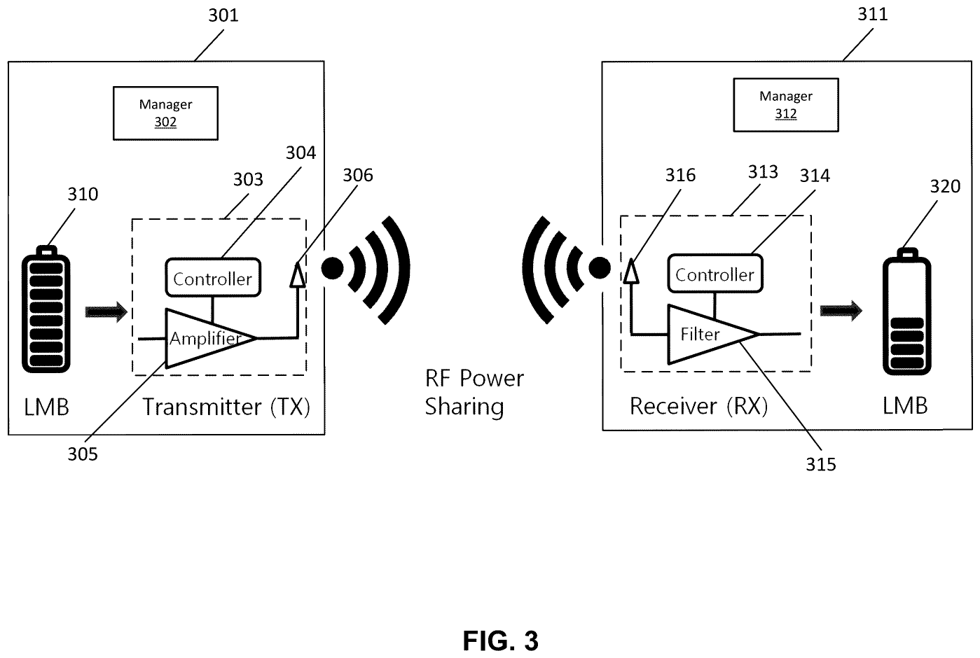

A more detailed schematic of the energy sharing transceiver component utilized in the energy sharing system is depicted in FIG. 3, which illustrates the use of RF power transfer technology. In FIG. 3, the energy stored in a first lithium metal battery (LMB) 310 of a transferring device 301 can be shared with a LMB 320 of a receiving device 311 via RF power sharing conducted between a first transceiver component 303 (operating in a transmitter mode) and a second transceiver component 313 operating in a receiver mode (e.g., as selected by a switch). As indicated above, the disclosed transceiver components can be configured or set to operating in either a transmission (i.e., energy supplying) mode or a reception (i.e., energy receiving) mode. Notably, each transceiver component may receive a command that configures the transmission or reception mode (e.g., sets a switch that designates the use of on-board transmission circuitry or reception circuitry) from a manager device (e.g., manager device 302 or 312). As shown in FIG. 3, transceiver component 303 may include a controller 304 that is coupled to an amplifier 305, which in turn is connected to at least one antenna 306. In some embodiments, the controller 304 includes a battery management module that is configured to facilitate the management and settings of the LMB 310. Although a single antenna is illustrated in FIG. 3, antenna 306 may represent a plurality of MIMO antennas located on transceiver component 303. Likewise, transceiver component 313 (which is operating in receiver mode) may include a controller 314 that is coupled to a filter 315, which in turn is connected to at least one antenna 316. Similar to antenna 306, antenna 316 may represent a plurality of MIMO antennas located on transceiver component 313. More specifically, in some embodiments, each energy sharing transceiver may further include high performance antenna devices equipped with focused arrays and beamforming capabilities to conduct MIMO operations at frequencies greater than 2 GHZ.

Although FIG. 3 only illustrates transceiver component 303 as including transmitting elements for the sake of clarity, it is understood that transceiver component 303 similarly includes RF receiving elements shown in transceiver component 313 (which is operating in a receiving mode). Likewise, transceiver component 313 includes transmission elements found in component 303.

In some embodiments, each of the energy sharing transceivers is configured to transmit and/or receive radio signals from millimeter wave (mmWave) frequencies (e.g., electromagnetic waves with a wavelength between 10 mm and 1 mm and a frequency between 30 GHz and 300 GHz) up to 300 Ghz. In some embodiments, each of the energy sharing transceivers includes a compound semiconductor device that permits the transceiver to operate at frequencies up to 400 Ghz.

In some embodiments, the transceiver component (i.e., “transceiver device”) transmits or receives power and/or energy regardless of a size and/or type of a host electronic device. For example, transceiver component 303 may be configured to transmit or receive energy regardless if it is a component of a small smartphone or an EV.

Although FIG. 3 depicts transferring device 301 including only a single transmitter component with a single amplifier, a single controller, and a single antenna, the devices of the disclosed subject matter may include a plurality of energy sharing transceiver devices, each of which includes a plurality of transmitters, receivers, controllers, and antennas.

In some embodiments, each of the LMBs 310 and 320 may include a gravimetric energy density that is equal to or exceeds 250 Wh/kg (watt-hour per kilogram) at a battery cell level.

In some embodiments, each of the LMBs 310 and 320 may include a cathode, a separator, and/or an anode free electrode (not shown). In some embodiments, each of the LMBs 310 and 320 includes a cathode with an average operating voltage and/or a nominal cell voltage greater than 3.0 Volts at the cell level. Further, each of the LMBs 310 and 320 may include a liquid electrolyte, or alternatively, a semi-solid electrolyte or a full solid-state electrolyte.

In some embodiments, each of the LMBs 310 and 320 comprises at least one lithium metal electrode that includes a substrate that is made from one or more of copper, stainless steel, nickel, or similarly conductive metal. Further, the lithium metal electrode itself (without the substrate) may include a thickness that ranges between (i.e., all values in between and including) 1 micrometer and 150 micrometers.

In some embodiments, each of the LMBs 310 and 320 includes a cell-to-pack or compact cell design with a system-level energy density greater than 150 Wh/kg (watt-hour per kilogram).

In some embodiments, the energy sharing transceiver may operate in the transmitting mode with an operating frequency that is greater than 2 Ghz (gigahertz) and wherein an amount of power that is transmitted is greater than 2 watts (W).

In some embodiments, the energy sharing transceiver may include at least one rectenna system (not shown) that combines an antenna and a rectifier for i) attaining higher efficiency in converting RF power to direct current (DC) power, and ii) achieving higher antenna gain, impedance matching, conversion efficiency.

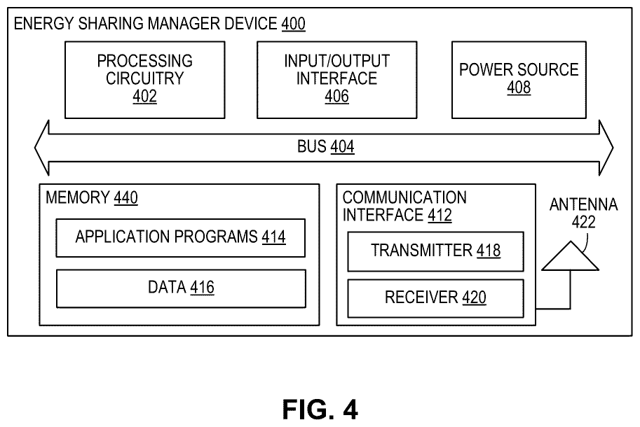

FIG. 4 shows an example energy sharing manager device 400 (e.g., similar to manager devices 302 and 312 in FIG. 3) in accordance with some embodiments. As used herein, a manager device refers to a device capable, configured, arranged and/or operable to communicate wirelessly with one or more energy sharing transceivers and/or other manager devices. Examples of a manager device include, but are not limited to, an on-board electrical vehicle console device, smart phone, mobile phone, personal digital assistant (PDA), tablet, laptop-embedded equipment (LEE), laptop-mounted equipment (LME), vehicle, vehicle-mounted or vehicle embedded/integrated wireless device, etc.

A manager device may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a manager device may not necessarily have a user in the sense of a human user who owns and/or operates the relevant device. The manager device 400 includes processing circuitry 402 that is operatively

coupled via a bus 404 to an input/output interface 406, a power source 408, a memory 440, a communication interface 412, and/or any other component, or any combination thereof. The level of integration between the components may vary from one manager device to another manager device. Further, certain manager devices may contain multiple instances of a component, such as multiple processors, memories, transceivers, transmitters, receivers, etc.

The processing circuitry 402 is configured to process instructions and data and may be configured to implement any sequential state machine operative to execute instructions stored as machine-readable computer programs in the memory 440. The processing circuitry 402 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 402 may include multiple central processing units (CPUs) and/or artificial intelligence (AI) processors.

In the example, the input/output interface 406 may be configured to provide an interface or interfaces to an input device, output device, or one or more input and/or output devices. Examples of an output device include a speaker, a sound card, a video card, a display, a monitor, an actuator, an emitter, a smartcard, another output device, or any combination thereof. An input device may allow a user to capture information into the manager device 400. Examples of an input device include a touch-sensitive or presence-sensitive display, a camera (e.g., a digital camera, a digital video camera, a web camera, etc.), a microphone, a sensor, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 408 is structured as a battery or battery pack. Other types of power sources, such as an external power source (e.g., an electricity outlet), photovoltaic device, or power cell, may be used. For example, the power source 208 may be the on board LMB 310 shown in FIG. 3. The power source 408 may further include power circuitry for delivering power from the power source 408 itself, and/or an external power source, to the various parts of the manager device 400 via input circuitry or an interface such as an electrical power cable. Delivering power may be, for example, for charging of the power source 408. Power circuitry may perform any formatting, converting, or other modification to the power from the power source 408 to make the power suitable for the respective components of the manager device 400 to which power is supplied.

The memory 440 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash memory devices, flash drives, and so forth. In one example, the memory 440 includes one or more application programs 414, such as an energy sharing management software, operating system, web browser application, a widget, or other related software application. Memory 440 may further include corresponding data 416, such as energy sharing management data, registration data, efficiency data, and the like. The memory 440 may store, for use by the manager device 400, any of a variety of various operating systems or combinations of operating systems.

The memory 440 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (cUICC), integrated UICC (iUICC) or a removable UICC commonly known as ‘SIM card.’ The memory 440 may allow the manager device 400 to access instructions, application programs and the like, stored on transitory or non-transitory memory media, to off-load data, or to upload data. An article of manufacture, such as one utilizing a communication system may be tangibly embodied as or in the memory 440, which may be or comprise a device-readable storage medium.

The processing circuitry 402 may be configured to communicate with an energy sharing network or other network using the communication interface 412. The communication interface 412 may comprise one or more communication subsystems and may include or be communicatively coupled to an antenna 422. The communication interface 412 may include one or more transceivers used to communicate, such as by communicating with one or more remote transceivers or devices capable of wireless communication (e.g., transceivers located on the EV, a manager device located on another EV, or a network hub in the energy sharing network). Each transceiver may include a transmitter 418 and/or a receiver 420 appropriate to provide network communications (e.g., optical, electrical, RF signaling, and so forth). Moreover, the transmitter 418 and receiver 420 may be coupled to one or more antennas (e.g., antenna 422) and may share circuit components, software or firmware, or alternatively be implemented separately.

In the illustrated embodiment, communication functions of the communication interface 412 may include RF communication, cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 402.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a manager device may provide an output of data captured by its sensors, through its communication interface 412, via a wireless connection to a network hub. Data captured by sensors of a manager device can be communicated through a wireless connection to a network hub via another manager device. The output may be periodic (e.g., once every 15 minutes if it reports the sensed temperature), random (e.g., to even out the load from reporting from several sensors), in response to a triggering event (e.g., when registered EVs come in proximity to each other), in response to a request (e.g., a user initiated request), or the like.

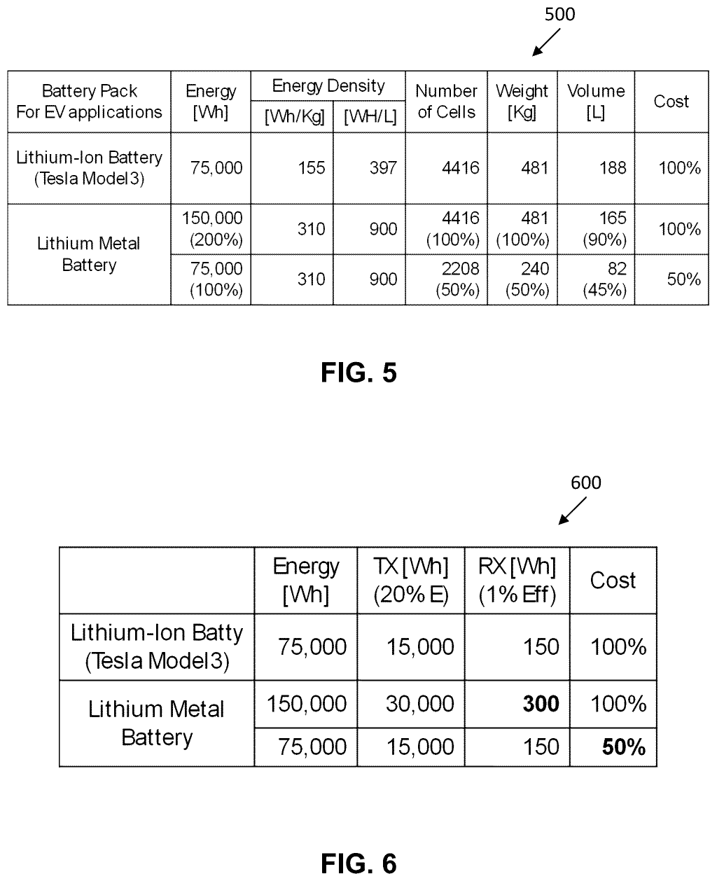

The high power and high energy performance of a LMB enables the disclosed system described herein to operate in a more efficient and/or cost effective manner. FIG. 5 depicts a table 500 that shows an example comparison between the use of a LIB and a LMB for EV applications. Notably, the type of battery used in an EV affects the wireless power transfer performance. For example, when compared to a LIB (e.g., as used in Tesla Model3 battery pack) which is typically rated as storing 75 kWh (kilowatt-hour) of energy, a LMB is able to provide twice as much energy (e.g., 150 kWh) in an EV battery pack that is of the same and/or comparable size and weight (as the LIB-based EV battery pack). Alternatively, the LMB battery pack can be configured provide the same energy (e.g., 75 kWh) as the LIB battery packet, but at half the size and weight (i.e., at similar cost). Thus, table 500 indicates that the use of an LMB in the disclosed system can enhance energy transfer efficiency (and/or mitigate the inefficiencies encountered) during the wireless power transfer by reducing the cost of the EV battery pack by half or by doubling the amount of energy stored (and potentially transferred) of an LIB based battery pack.

In some embodiments, it can be assumed that a wireless power transfer system can currently transfer power at 1% efficiency, and 20% (i.e., anywhere between 10% and 100%) of the cell's (or battery pack's) stored energy is used by the power-transferring EV. At the power-transferring EV, LMBs having the same size as LIBs can transfer twice as much power. Power-transferring EVs equipped with an LMB battery pack can transfer the same amount of energy as those EVs equipped with a LIB battery pack at half of cost (i.e., half the battery size and weight). In either case, utilization of a LMB battery pack can double the system's efficiency. Notably, this is significant factor that will promote the commercialization and adoption of an energy sharing system that includes the wireless transfer of energy between high energy, high power, and ultra-lightweight LMBs.

FIG. 6 depicts a table 600 comparing various wireless transmission and reception characteristics between a lithium ion battery and a lithium metal battery for EV applications. Notably, table 600 indicates that a lithium metal battery can transmit and receive twice the amount of energy at the same cost as a comparable LIB, or transmit and receive the same amount of energy at half of the cost as compared to a LIB. More specifically, table 6 indicates that i) a LMB can transmit 30 kWh of energy as compared to 15 kWh of a LIB at a similar “100%” battery cost, ii) a LMB can receive 300 Wh (watt-hour) of energy as compared to 150 Wh of a LIB at the same battery cost, and iii) a LMB can transmit the same amount of 15 kWh (kilowatt-hour) of energy as a LIB, but at 50% of the battery cost.

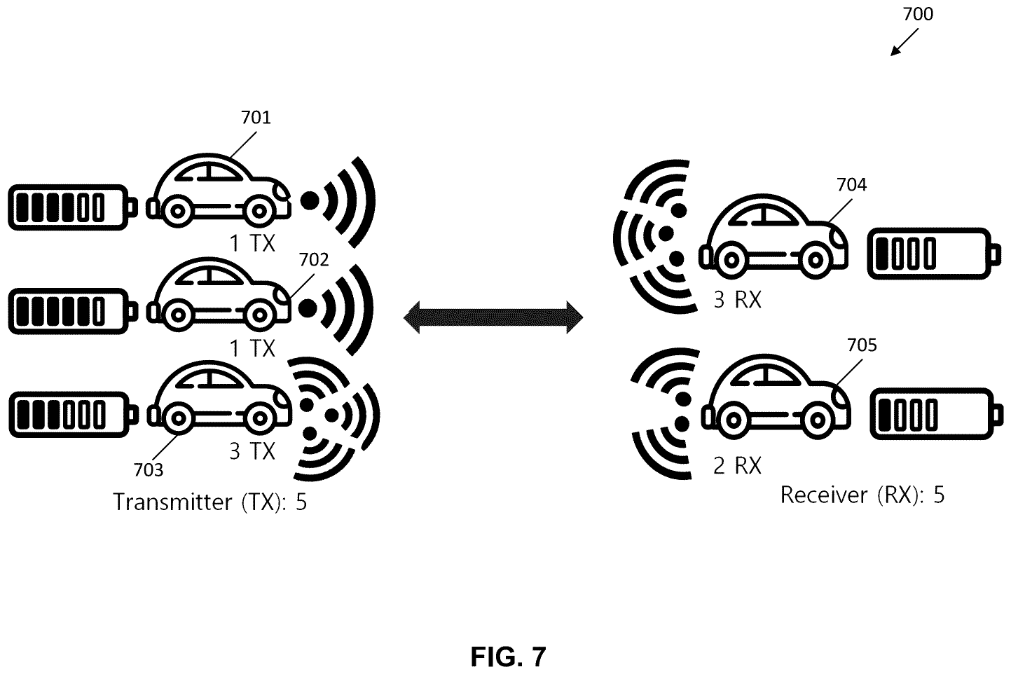

In FIG. 7, the system 700 illustrates a plurality of EVs 701-703 that are respectively equipped with LMBs and operating in an energy transmitting mode (i.e., transceivers located on EVs 701-703 are configured to operate in an energy transmitting mode) that are configured to provide power to a second plurality of EVs 704-705 respectively equipped with LMBs operating in an energy receiving mode (i.e., transceivers located on EVs 704-705 are configured to operate in an energy receiving mode). In this example, receiving EV 704 may utilize 3 MIMO antennas on its transceiver component to receive power from one or more of transmitting EVs 701-703. Similarly, receiving EV 705 may utilize 2 MIMO antennas on its transceiver component to receive power from one or more of transmitting EVs 701-703. Further, as an example, transmitting EV 703 may utilize 3 MIMO antennas on its transceiver component to transmit power to one or both of receiving EVs 704-705.

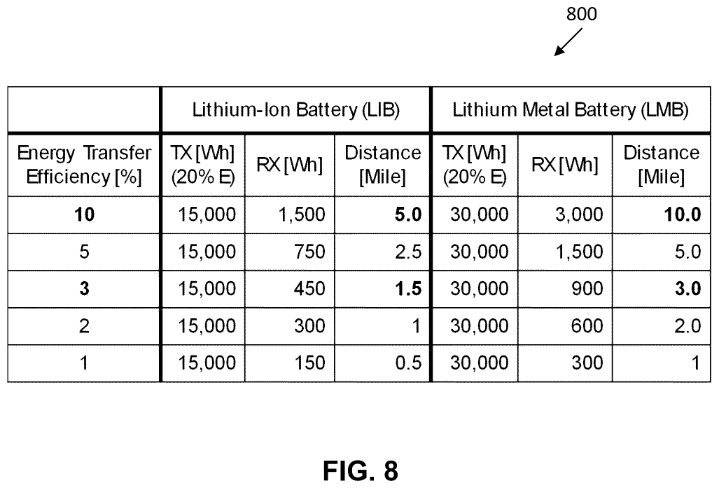

Another example case is explained in table 800 of FIG. 8, which shows the practical utilization of a wireless energy sharing system with high energy battery. For example, a Tesla Model3 EV can travel 3 miles using 900 Wh of received energy. Making the same assumptions made above, the EV operating distances enabled by the shared energy provided by the wireless power transferring system doubles with the use of an LMB battery pack as compared between the use of a LIB battery pack (if one could be practically used). In order to achieve a reasonable operating distance, the system equipped with the LMB battery pack is able to travel 10 miles if the power transfer efficiency is 10%. In contrast, an EV equipped with a LIB battery pack is only able to travel 5 miles. The usefulness of the disclosed energy sharing concept allows an EV to receive power from multiple sources (e.g., FIG. 7) when the transfer efficiency is 1%; the system with LMB can run 10 miles, which is the same distance with 10% efficiency, by receiving power from 10 transferring EVs, while that with a LIB battery pack is only 5 miles.

The disclosed subject matter affords many advantages over the current state of the art of rechargeable battery charging. For example, the energy sharing system allows an EV that urgently requires power to obtain energy without the need to visit a charging station or charging stand. In addition, the need for charging station itself can be obviated, since the disclosed transceiver components only require a very small amount of space as compared to existing installed electricity charging stations. The disclosed simultaneous multi-receiving and/or transmitting transceiver functionality may also lead to other energy harvesting and sharing concepts. This will be especially beneficial in a large metropolitan area, where space is limited for constructing and/or installing such charging stations/areas at city residences and/or in company parking lots.

In addition, from a battery performance point of view, the manner of slow charging (e.g., 0.1 C) that is utilized by the disclosed subject matter significantly increases the lifetime (e.g., charging cycles) of a rechargeable battery. Also, wireless charging will rapidly increase the battery demand further in many areas (not just limited to EV applications, but in many consumer, industrial, and medical areas) and significantly reduce the overall cost of a conventional charging station building.

Another advantage of the example RF energy sharing system is its ability to transfer electrical energy and data at the same time. Notably, such an ability to simultaneously transfer energy and data is not possible via other transfer technologies, such as via an inductive coupling system or a magnetic-resonant power transfer system. This feature helps in realizing the disclosed energy sharing system, as information on the transferred power, received power, and scheduled time for sharing can be communicated. In addition, RF power transfer technologies are not limited to potential alignment issues (e.g., precise alignment of the inductor pad with battery device) typically encountered with magnetic-resonant power transfer solutions.

The RF wireless power and communication system, combined with high-power and high-energy lithium metal batteries, facilitates an energy sharing community by enabling device-to-device energy transfer. This system allows unlimited access to charging capabilities by simultaneously communicating with other devices. Ultimately, it eliminates all structural and location-based limitations for receiving and transmitting energy and power to other devices.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The embodiments shown and described in the preceding description are for illustration and explanation only and are not intended to limit the scope of the disclosed subject matter in the appended claims.

What is claimed is:

1. A wireless energy sharing system, comprising:
a high energy and high power battery device configured to store energy and includes a lithium metal anode; and
an energy sharing transceiver device that is configured to:
transmit, via radio frequency (RF) communications, energy stored in the battery device to one or more energy sharing additional transceiver devices while operating in an energy transmitting mode;
receive energy from the one or more energy sharing additional transceiver devices and store the received energy in the battery device while operating in an energy receiving mode; and
transmit and/or receive, via the RF communications, energy sharing data simultaneously with the respective transmission and/or reception of the energy.

2. The system of claim 1 wherein each of the transceiver device and the additional transceiver devices is configured to transmit and/or receive radio signals from millimeter wave (mmWave) frequencies up to 300 Ghz.

3. The system of claim 1 wherein the transceiver device transmits or receives the energy regardless of a size and/or type of a host electronic device.

4. The system of claim 1 wherein each of the energy sharing transceiver device and the additional energy sharing transceiver devices includes a plurality of transmitters, receivers, controllers, and antennas.

5. The system of claim 1 wherein the battery device includes a gravimetric energy density that is equal to or exceeds 250 Wh/kg at a battery cell level.

6. The system of claim 1 wherein the battery device includes a cathode, a separator, and/or an anode free electrode.

7. The system of claim 6 wherein the battery device includes a liquid electrolyte.

8. The system of claim 6 wherein the battery device includes a semi-solid electrolyte or a full solid-state electrolyte.

9. The system of claim 1, wherein the battery device comprises at least one lithium metal electrode that includes a substrate that is made from one or more of copper, stainless steel, or nickel.

10. The system of claim 9, wherein the thickness of each of the at least one lithium metal electrode ranges between 1 micrometer and 150 micrometers, excluding any substrate.

11. The system of claim 1, wherein the battery device includes a cathode with an average operating voltage and/or nominal cell voltage greater than 3.0 Volts at a cell level.

12. The system of claim 1, wherein the battery device includes a cell-to-pack or compact cell design with a system-level energy density greater than 150 Wh/kg.

13. The system of claim 1 further comprising a battery management module in a controller of each energy sharing transceiver.

14. The system of claim 1, wherein an operating frequency of the energy sharing transceiver operating in the transmitting mode is higher than 2 Ghz and an amount of power transmitted is greater than 2 W.

15. The system of claim 1, wherein the energy sharing transceiver includes at least one rectenna system that combines an antenna and a rectifier for i) attaining higher efficiency in converting RF power to DC power, and ii) achieving higher antenna gain, impedance matching, conversion efficiency.

16. The system of claim 1, wherein the energy sharing transceiver includes a compound semiconductor device for operating at frequencies up to 400 Ghz.

17. The system of claim 1, wherein the energy sharing transceiver further includes high performance antenna devices equipped with focused arrays and beamforming capabilities to conduct multiple input, multiple output (MIMO) operations at frequencies greater than 2 GHz.

18. The system of claim 1, wherein the system includes an energy sharing system software application that is configured to facilitate the communications between users and/or host devices registered in the wireless energy sharing system.
